(19) United States
(12) Patent Application Publication
(10) Pub. No.: US 2026/0259771 A1
(43) Pub. Date: Sep. 3, 2026

(54) GENERATION OF COMPLIANCE GRAPH FOR WORKLOAD RESOURCES

(71) Applicant: International Business Machines Corporation, Armonk, NY (US)

(72) Inventors: Xiao Ling Chen, Changping District (CN); Heng Wang, Changping District (CN); Zhan Peng Huo, Beijing (CN); Yu Zui You, Ningbo (CN)

(21) Appl. No.: 19/066,978

(22) Filed: Feb. 28, 2025

(51) Int. Cl. G06F 9/50

(52) U.S. Cl. CPC G06F 9/5027

(57) ABSTRACT

Generation of a compliance graph includes receiving a deployment input associated with a set of workload resources. Compliance data associated with the set of workload resources is retrieved. The compliance graph associated with the set of workload resources is generated based on the retrieved compliance data. A plurality of vulnerabilities associated with a plurality of workload resources is monitored. The plurality of workload resources includes the set of workload resources. A set of vulnerabilities are identified from the plurality of vulnerabilities. A set of vulnerability metrics associated with the set of vulnerabilities are determined. The compliance graph is updated based on the set of vulnerability metrics.

### BACKGROUND

The disclosure relates to containerization and more particularly, to workload resources in container platforms.

Container (or containerized) applications are a foundational technology for modern software development, enabling scalability, portability, and efficient management of application workloads. Containers enable developers to package applications with dependencies of the applications, ensuring consistency across different environments. As the size and complexity of the applications increase, interdependencies between the containers also increase, thereby amplifying operational challenges. Additionally, the frequent emergence of common vulnerabilities and exposures (CVEs) related to the container applications and complex interdependencies between the containers introduces challenges for patching and updating the container applications to maintain security.

### SUMMARY

In various embodiments of the disclosure, a computer-implemented method for generation of a compliance graph for workload resources is provided. The computer-implemented method includes receiving, by a computer, a deployment input associated with a set of workload resources. The computer-implemented method further includes retrieving, by the computer, compliance data based on the received deployment input. The retrieved compliance data is associated with the set of workload resources. The retrieved compliance data includes at least one of a set of cryptographic certificates associated with the set of workload resources or a set of keys associated with the set of workload resources. The computer-implemented method further includes monitoring, by the computer, a plurality of vulnerabilities associated with a plurality of workload resources based on the generated compliance graph. The plurality of workload resources includes the set of workload resources. The plurality of vulnerabilities includes a set of common vulnerability exposures. The computer-implemented method further includes identifying, by the computer, a set of vulnerabilities from the monitored plurality of vulnerabilities. The identified set of vulnerabilities impacts at least one application installed on the set of workload resources. The computer-implemented method further includes determining, by the computer, a set of vulnerability metrics associated with the identified set of vulnerabilities. The computer-implemented method further includes determining, by the computer, a set of severity scores associated with the set of vulnerability metrics. The computer-implemented method further includes updating, by the computer, the compliance graph based on the determined set of vulnerability metrics. The updated compliance graph includes the determined set of severity scores.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for generation of compliance graph for workload resources. The program instructions further cause the processor set to receive a deployment input associated with a set of workload resources. The program instructions further cause the processor set to retrieve compliance data based on the received deployment input. The retrieved compliance data is associated with the set of workload resources. The retrieved compliance data includes at least one of a set of cryptographic certificates associated with the set of workload resources or a set of keys associated with the set of workload resources. The program instructions further cause the processor set to generate a compliance graph associated with the set of workload resources based on the retrieved compliance data. The program instructions further cause the processor set to monitor a plurality of vulnerabilities associated with a plurality of workload resources based on the generated compliance graph. The plurality of workload resources includes the set of workload resources. The plurality of vulnerabilities includes a set of common vulnerability exposures. The program instructions further cause the processor set to identify a set of vulnerabilities from the monitored plurality of vulnerabilities. The identified set of vulnerabilities impacts at least one application installed on the set of workload resources. The program instructions further cause the processor set to obtain a set of vulnerability metrics associated with the identified set of vulnerabilities. The program instructions further cause the processor set to obtain a set of severity scores associated with the set of vulnerability metrics. The program instructions further cause the processor set to update the compliance graph based on the obtained set of vulnerability metrics. The updated compliance graph includes the obtained set of severity scores. The program instructions further cause the processor set to render the updated compliance graph on a user device.

In various embodiments of the disclosure, a computer-program product for generation of a compliance graph associated with a set of workload resources is described.

Additional technical features and benefits are realized through the techniques of the disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures wherein:

FIG. 1 is a diagram that illustrates a computing environment for generation of compliance graph for workload resources, in accordance with an embodiment of the disclosure;

FIG. 2 is a diagram that illustrates an environment for generation of a compliance graph for workload resources, in accordance with an embodiment of the disclosure;

FIGS. 3A and 3B are diagrams that collectively illustrate exemplary operations for the generation of the compliance graph for the workload resources, in accordance with an embodiment of the disclosure;

FIG. 4 is a diagram that illustrates an exemplary compliance graph, in accordance with an embodiment of the disclosure; and

FIG. 5 is a diagram that illustrates a flowchart of an exemplary method for the generation of the compliance graph for the workload resources.

### DETAILED DESCRIPTION

Containers encapsulate application code along with dependencies of the applications, enabling consistent operation across diverse environments. Platforms such as Kubernetes® orchestrate the containers, automating deployment and scaling across diverse environments. Additionally, Kubernetes® along with additional container orchestration systems, support dynamic and flexible container deployment, allowing for complex application architecture that can scale and adapt to changing workloads. As the size and complexity of the applications increase, interdependencies between the containers also increase, thereby amplifying operations challenges. Additionally, the frequent emergence of cybersecurity vulnerabilities (such as publicly disclosed common vulnerabilities and exposures (CVEs)) related to the container applications and complex interdependencies between the containers introduces challenges in maintaining security by patching and updating the container applications. Examples of the CVEs may include runtime vulnerabilities, privilege escalation vulnerabilities, container escape vulnerabilities, and the like.

Conventional systems attempt to address data security associated with containerized environments by capturing security alerts raised by conditions and events such as security breaches that have already occurred. Further, conventional systems organize previously generated alerts, vulnerabilities, and misconfigurations in different categories (e.g., alert categories, vulnerability categories, and misconfiguration category) to determine category association rules. Additionally, based on the category association rule, conventional systems estimate the possibility of vulnerabilities or exposure in different containerized environments. Alternatively, conventional systems analyzes historical security data and forecasts various upcoming trends to predict potential security risks. However, this approach is limited by reliance on the prediction accuracy of the conventional system and may be affected by the continuous emergence of the CVEs that may be different compared to additional historical CVEs.

To address these issues, a system that can generate a compliance graph for workload resources is disclosed. The compliance graph is a visual representation of adherence to regulations and standards of resources used by any organization. The system receives a deployment input associated with a set of workload resources. The system generates a compliance graph associated with the set of workload resources. Further, the system monitors a set of vulnerabilities associated with the set of workload resources. Additionally, the system determines a set of vulnerability metrics associated with the identified set of vulnerabilities. The system may further update the compliance graph based on the set of vulnerability metrics.

The disclosed system continuously monitors the set of vulnerabilities from various sources in real-time or near real-time. By continuously monitoring new CVEs, the system ensures that the compliance graph is up to date. Thus, continuous updating of the compliance graph eliminates reliance on static compliance assessments, thereby enabling the system to adapt seamlessly to evolve configurations or updates associated with the set of workload resources. Further, the generation of the compliance graph ensures scalability by integrating complex dependencies within the set of workload resources. This structured representation allows the system to efficiently track and update security status of each workload resources in real-time, ensuring continuous and up to date vulnerability assessment even as complexity of the set of workload resources varies over time.

In various embodiments of the disclosure, a computer-implemented method for generation of a compliance graph for workload resources is provided. The computer-implemented method includes receiving, by a computer, a deployment input associated with a set of workload resources. The computer-implemented method further includes retrieving, by the computer, compliance data based on the received deployment input. The retrieved compliance data is associated with the set of workload resources. The retrieved compliance data includes at least one of a set of cryptographic certificates associated with the set of workload resources or a set of keys associated with the set of workload resources. The computer-implemented method further includes monitoring, by the computer, a plurality of vulnerabilities associated with a plurality of workload resources based on the generated compliance graph. The plurality of workload resources includes the set of workload resources. The plurality of vulnerabilities includes a set of common vulnerability exposures. The computer-implemented method further includes identifying, by the computer, a set of vulnerabilities from the monitored plurality of vulnerabilities. The identified set of vulnerabilities impacts at least one application installed on the set of workload resources. The computer-implemented method further includes determining, by the computer, a set of vulnerability metrics associated with the identified set of vulnerabilities. The computer-implemented method further includes determining, by the computer, a set of severity scores associated with the set of vulnerability metrics. The computer-implemented method further includes updating, by the computer, the compliance graph based on the determined set of vulnerability metrics. The updated compliance graph includes the determined set of severity scores.

In various embodiments of the disclosure, the computer-implemented method further includes generating, by the computer, a data structure based on the determination of the set of vulnerability metrics. The data structure includes the identified set of vulnerabilities and the determined set of vulnerability metrics. The computer-implemented method further includes parsing, by the computer, the data structure. The computer-implemented method further includes identifying, by the computer, a workload resource from the set of workload resources based on the parsing of the data structure. The computer-implemented method further includes identifying, by the computer, a vulnerability metric from the determined set of vulnerability metrics based on the parsing of the data structure. The identified vulnerability metric is associated with the workload resource. The computer-implemented method further includes updating, by the computer, the compliance graph based on the identified workload resource and the identified vulnerability metric.

In various embodiments of the disclosure, the compliance graph includes a set of nodes and a set of edges. The set of nodes corresponds to the set of workload resources. Each edge of the set of edges corresponds to a link between two workload resources of the set of workload resources.

In various embodiments of the disclosure, the set of nodes includes a first compliance status of the set of workload resources. The set of edges includes a second compliance status of the link between the two workload resources of the set of workload resources.

In various embodiments of the disclosure, the deployment input corresponds to at least one of a set of instructions associated with deployment of the set of workload resources or configuration data associated with deployment of the set of workload resources.

In various embodiments of the disclosure, the computer-implemented method further includes generating, by the computer, an alert based on the updated compliance graph. The computer-implemented method further includes rendering, by the computer, the generated alert on a user device.

In various embodiments of the disclosure, the computer-implemented method further includes determining, by the computer, the set of severity scores based on the set of vulnerability metrics and a common vulnerability scoring system.

In various embodiments of the disclosure, the set of workload resources includes at least one of a set of pods or a set of containers.

In various embodiments of the disclosure, a computer system is described. The computer system includes a processor set, one or more computer-readable storage media, and program instructions stored on the one or more computer-readable storage media. The program instructions executable by the processor set to cause the processor set to perform a method for generation of compliance graph for workload resources. The program instructions further cause the processor set to receive a deployment input associated with a set of workload resources. The program instructions further cause the processor set to retrieve compliance data based on the received deployment input. The retrieved compliance data is associated with the set of workload resources. The retrieved compliance data includes at least one of a set of cryptographic certificates associated with the set of workload resources or a set of keys associated with the set of workload resources. The program instructions further cause the processor set to generate a compliance graph associated with the set of workload resources based on the retrieved compliance data. The program instructions further cause the processor set to monitor a plurality of vulnerabilities associated with a plurality of workload resources based on the generated compliance graph. The plurality of workload resources includes the set of workload resources. The plurality of vulnerabilities includes a set of common vulnerability exposures. The program instructions further cause the processor set to identify a set of vulnerabilities from the monitored plurality of vulnerabilities. The identified set of vulnerabilities impacts at least one application installed on the set of workload resources. The program instructions further cause the processor set to obtain a set of vulnerability metrics associated with the identified set of vulnerabilities. The program instructions further cause the processor set to obtain a set of severity scores associated with the set of vulnerability metrics. The program instructions further cause the processor set to update the compliance graph based on the obtained set of vulnerability metrics. The updated compliance graph includes the obtained set of severity scores. The program instructions further cause the processor set to render the updated compliance graph on a user device.

In various embodiments of the disclosure, the program instructions further cause the processor set to generate a data structure based on the obtained set of vulnerability metrics. The data structure includes the identified set of vulnerabilities and the obtained set of vulnerability metrics. The program instructions further cause the processor set to parse the data structure. The program instructions further cause the processor set to identify a workload resource from the set of workload resources based on the parsed data structure. The program instructions further cause the processor set to identify a vulnerability metric from the obtained set of vulnerability metrics based on the parsed data structure. The identified vulnerability metric is associated with the workload resource. The program instructions further cause the processor set to update the compliance graph based on the identified workload resource and the identified vulnerability metric.

In various embodiments of the disclosure, the compliance graph includes a set of nodes and a set of edges. The set of nodes corresponds to the set of workload resources. Each edge of the set of edges corresponds to a link between two workload resources of the set of workload resources.

In various embodiments of the disclosure, the set of nodes includes a first compliance status of the set of workload resources. The set of edges includes a second compliance status of the link between the two workload resources of the set of workload resources.

In various embodiments of the disclosure, the deployment input corresponds to at least one of a set of instructions associated with the deployment of the set of workload resources or configuration data associated with deployment of the set of workload resources.

In various embodiments of the disclosure, the program instructions further cause the processor set to generate an alert based on the updated compliance graph. The program instructions further cause the processor set to render the generated alert on the user device.

In various embodiments of the disclosure, the program instructions further cause the processor set to obtain the set of severity scores based on the set of vulnerability metrics and a common vulnerability scoring system.

In various embodiments of the disclosure, the set of workload resources includes at least one of a set of pods or a set of containers.

In various embodiments of the disclosure, a computer-program product is described. The computer-program product includes one or more computer-readable storage media and program instructions stored on the one or more computer-readable storage media to perform operations for generation of compliance graph for workload resources. The operations include receiving a deployment input associated with a set of workload resources of a plurality of workload resources. The operations further include retrieving compliance data associated with the set of workload resources. The retrieved compliance data includes at least one of a set of cryptographic certificates associated with the set of workload resources or a set of keys associated with the set of workload resources. The operations further include generating the compliance graph associated with the set of workload resources based on the retrieved compliance data. The operations further include monitoring a plurality of vulnerabilities associated with the plurality of workload resources based on the generated compliance graph. The plurality of vulnerabilities includes a set of common vulnerability exposures. The operations further include identifying a set of vulnerabilities from the monitored plurality of vulnerabilities. The identified set of vulnerabilities impacts at least one application installed on the set of workload resources. The operations further include determining a set of vulnerability metrics associated with the identified set of vulnerabilities. The operations further include determining a set of severity scores associated with the set of vulnerability metrics. The operations further include updating the compliance graph based on the determined set of vulnerability metrics. The updated compliance graph includes the determined set of severity scores.

In various embodiments of the disclosure, the program instructions stored on the one or more computer-readable storage media to perform operations for generating a data structure based on the determination of the set of vulnerability metrics. The data structure includes the identified set of vulnerabilities and the determined set of vulnerability metrics. The operations further include parsing the data structure. The operations further include identifying a workload resource from the set of workload resources based on the parsing of the data structure. The operations further include identifying a vulnerability metric from the determined set of vulnerability metrics based on the parsing of the data structure. The identified vulnerability metric is associated with the workload resource. The operations further include updating the compliance graph based on the identified workload resource and the identified vulnerability metric.

In various embodiments of the disclosure, the compliance graph includes a set of nodes and a set of edges. The set of nodes corresponds to the set of workload resources. Each edge of the set of edges corresponds to a link between two workload resources of the set of workload resources.

In various embodiments of the disclosure, the set of nodes includes a first compliance status of the set of workload resources. The set of edges includes a second compliance status of the link between the two workload resources of the set of workload resources.

Additional technical features and benefits are realized through the various processes of the disclosure. Embodiments and aspects of the disclosure are described in detail herein and are considered a part of the claimed subject matter. For a better understanding, refer to the detailed description and to the drawings.

Various aspects of the disclosure are described by narrative text, flowcharts, block diagrams of computer systems, and/or block diagrams of the machine logic included in computer-program product (CPP) embodiments. With respect to any flowcharts, depending upon the technology involved, the operations can be performed in a different order than what is shown in a given flowchart. For example, again depending upon the technology involved, two operations shown in successive flowchart blocks could be performed in reverse order, as a single integrated operation, concurrently, or in a manner at least partially overlapping in time.

A computer-program product embodiment (“CPP embodiment” or “CPP”) is a term used in the disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium could be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the disclosure, is not to be construed as storage in the form of transitory signals per se, such as radio waves or additional freely propagating electromagnetic waves, electromagnetic waves propagating through a waveguide, light pulses passing through a fiber optic cable, electrical signals communicated through a wire, and/or additional transmission media. As will be understood by those of skill in the art, data is typically moved at some occasional points in time during normal operations of a storage device, such as during access, de-fragmentation, or garbage collection, but this does not render the storage device as transitory because the data is not transitory when stored.

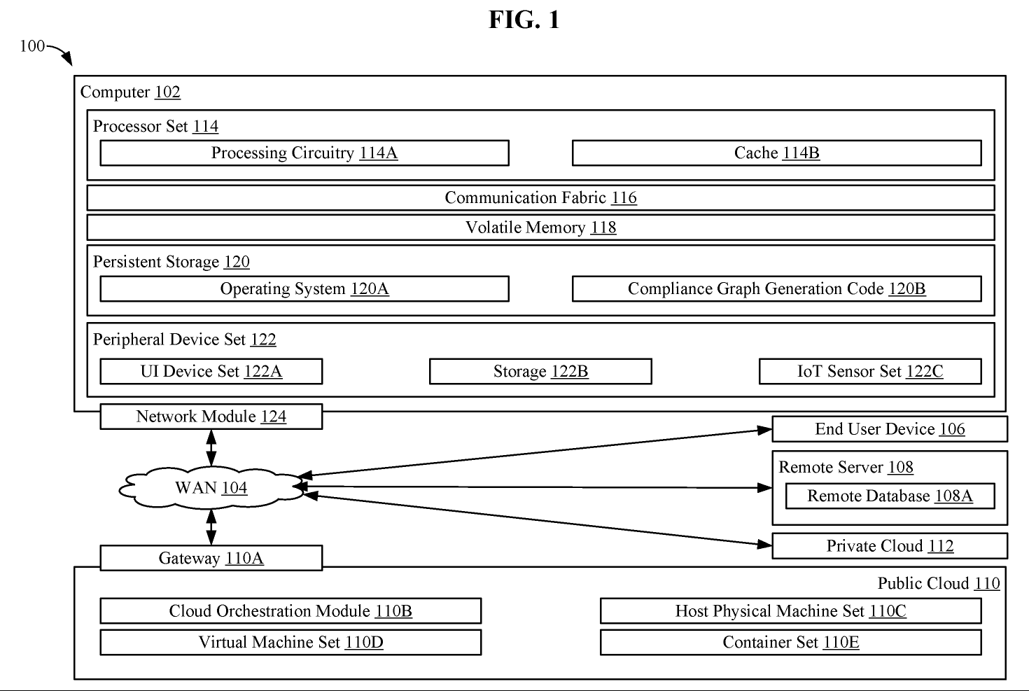

FIG. 1 is a diagram that illustrates a computing environment for generation of compliance graph for workload resources, in accordance with an embodiment of the disclosure. With reference to FIG. 1, there is shown a computing environment 100 that contains an example of an environment for the execution of at least some of the computer code involved in performing the disclosed methods, such as a compliance graph generation code 120B. In addition to the compliance graph generation code 120B, computing environment 100 includes, for example, a computer 102, a wide area network (WAN) 104, an end user device (EUD) 106, a remote server 108, a public cloud 110, and a private cloud 112. In this embodiment of the disclosure, the computer 102 includes a processor set 114 (including a processing circuitry 114A and a cache 114B), a communication fabric 116, a volatile memory 118, a persistent storage 120 (including an operating system 120A and the compliance graph generation code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a mainframe computer, a quantum computer, a virtual machine, or any form of a computer or a mobile device now known or to be developed in the future that may be configured to run a program, accessing a network or querying a database, such as the remote database 108A. As is well understood in the art of computer technology, and depending upon the technology, the performance of a computer-implemented method may be distributed among multiple computers and/or between multiple locations. In an embodiment, in this presentation of the computing environment 100, detailed discussion is focused on a single computer, specifically the computer 102, to keep the presentation as simple as possible. The computer 102 may be located in a cloud, although not shown in a cloud in FIG. 1. In an alternate embodiment, the computer 102 may not be in a cloud except to any extent as may be affirmatively indicated.

The processor set 114 includes one or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the disclosed methods”). These computer-readable program instructions are stored in various types of computer-readable storage media, such as the cache 114B and the additional storage media discussed below. The program instructions, and associated data, are accessed by the processor set 114 to control and direct the performance of the disclosed methods. In computing environment 100, at least some of the instructions for performing the disclosed methods may be stored in the dynamic modification of the compliance graph generation code 120B in persistent storage 120.

The communication fabric 116 is the signal conduction path that allows the various components of computer 102 to intercommunicate. Typically, this fabric is made of switches and electrically conductive paths, such as the switches and electrically conductive paths that make up buses, bridges, physical input/output ports, and the like. Various types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not general case unless affirmatively indicated. In the computer 102, the volatile memory 118 is located in a single package and is internal to the computer 102, but alternatively or additionally, the volatile memory 118 may be distributed over multiple packages and/or located externally with respect to the computer 102.

The persistent storage 120 is any form of non-volatile storage for computers that is now known or to be developed in the future. The non-volatility of this storage means that the stored data is maintained regardless of whether power is being supplied to the computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the compliance graph generation code 120B typically includes at least some of the computer code involved in performing the disclosed methods.

The peripheral device set 122 includes the set of peripheral devices of the computer 102. Data communication connections between the peripheral devices and the additional components of the computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments of the disclosure, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments of the disclosure, the storage 122B may take the form of a quantum computing storage device for storing data in the form of qubits. In embodiments of the disclosure where the computer 102 may have a large amount of storage (for example, where the computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, a first sensor may be a thermometer, and a second sensor may be a motion detector.

The network module 124 is the collection of computer software, hardware, and firmware that allows the computer 102 to communicate with one or more computers through the WAN 104. The network module 124 may include hardware, such as modems or Wi-Fi signal transceivers, software for packetizing and/or de-packetizing data for communication network transmission, and/or web browser software for communicating data over the internet. In some embodiments of the disclosure, network control functions, and network forwarding functions of the network module 124 are performed on the same physical hardware device. In various embodiments of the disclosure (for example, embodiments that utilize software-defined networking (SDN)), the control functions and the forwarding functions of the network module 124 are performed on physically separate devices, such that the control functions manage several different network hardware devices. Computer-readable program instructions for performing the disclosed methods can typically be downloaded to the computer 102 from an external computer or external storage device through a network adapter card or network interface included in the network module 124.

The WAN 104 is a wide area network (for example, the internet) that may be configured to communicate computer data over non-local distances by any technology for communicating computer data, now known or to be developed in the future. In some embodiments of the disclosure, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any computer system that is controlled by an end user (for example, a customer of an enterprise that operates the computer 102) and may take any of the forms discussed above in connection with the computer 102. The EUD 106 typically receives helpful and useful data from the operations of the computer 102. For example, in a hypothetical case where the computer 102 is designed to provide a recommendation to an end user, this recommendation would typically be communicated from the network module 124 of the computer 102 through the WAN 104 to the EUD 106. In this way, the EUD 106 can display, or alternatively present recommendations to an end user. In some embodiments of the disclosure, the EUD 106 may be a client device, such as a thin client, heavy client, mainframe computer, desktop computer, and so on.

The remote server 108 is any computer system that serves at least some data and/or functionality to the computer 102. The remote server 108 may be controlled and used by the same entity that operates the computer 102. The remote server 108 represents the machine(s) that collect and store helpful and useful data for use by the one or more computers, such as the computer 102. For example, in a hypothetical case where the computer 102 is designed and programmed to provide a recommendation based on historical data, then this historical data may be provided to the computer 102 from the remote database 108A of the remote server 108.

The public cloud 110 is any computer system available for use by multiple entities that provides on-demand availability of computer system resources and/or additional computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows the public cloud 110 to communicate through the WAN 104.

Some further explanation of virtualized computing environments (VCEs) will now be provided. VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in the container. A computer-program running on an ordinary operating system can utilize resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in various embodiments of the disclosure, the private cloud 112 may be disconnected from the internet entirely and only accessible through a local/private network. A hybrid cloud is a composition of multiple clouds of different types (for example, private, community, or public cloud types), often respectively implemented by different vendors. Each cloud of the multiple clouds remains a separate and discrete entity, but the larger hybrid cloud architecture is bound together by standardized or proprietary technology that enables orchestration, management, and/or data/application portability between the multiple constituent clouds. In this embodiment of the disclosure, the public cloud 110 and the private cloud 112 are both part of a larger hybrid cloud.

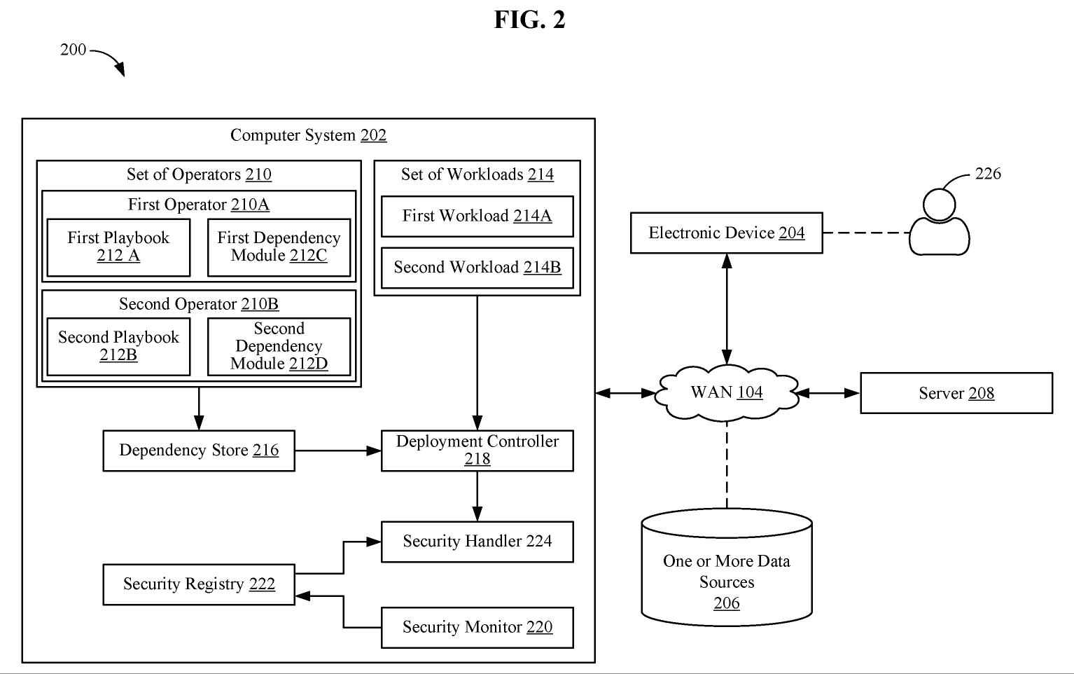

FIG. 2 is a diagram that illustrates an environment for generation of a compliance graph for workload resources, in accordance with an embodiment of the disclosure. FIG. 2 is explained in conjunction with elements from FIG. 1. With reference to FIG. 2, there is shown a diagram of a network environment 200. The network environment 200 includes a computer system 202, an electronic device 204, one or more data sources 206, and a server 208. Further, the network environment 200 includes the WAN 104 of FIG. 1. In an embodiment of the disclosure, the computer system 202 may be an exemplary embodiment of the computer 102 of FIG. 1.

The computer system 202 may include suitable logic, circuitry, interfaces, and/or code that may be configured to generate of the compliance graph for the workload resources. The computer system 202 may be configured to receive a deployment input associated with a set of workload resources. By way of example, and not by limitation, the set of workload resources may include containers, pods, physical servers, virtual machines, cloud resources, storage systems, and the like. Additionally, the deployment input may define a set of rules, constraints, and parameters under which the set of workload resources are to be deployed or managed.

A container may correspond to a lightweight, portable unit of software that encapsulates an application and dependencies of the application, allowing the container to run consistently across different environments such as a development environment, a testing environment, a staging environment, and the like. Further, the pod may correspond to a smallest deployable unit in Kubernetes® that encapsulates one or more containers that share the same network namespace, storage, and configuration options. The Pod (or pods) may enable tightly coupled containers to run together in an isolated environment, providing communication and resource sharing among the containers. For example, the pod may include a web server container to handle hypertext transfer protocol (HTTP) requests from clients. Additionally, the pod may include a database container that stores and retrieves data from a web application. Since both the web server and database are within the same pod, the web server and the database share the same network namespace, allowing the web server and the database to communicate directly using “localhost” that refer to a network address of a network interface of the pod. Thus, this setup enables fast data retrieval and storage without the latency that may typically be associated with inter-pod communication.

The electronic device 204 may include suitable logic, circuitry, interfaces, and/or code that may be configured to receive first input data from user 226. In an embodiment, the first input data may include a set of tasks or resource deployment preconditions for a particular containerized system. For example, the first input data may specify container orchestration requirements associated with the set of workload resources. Examples of the container orchestration requirements may include memory and CPU allocation, container images, networking configurations, and security policies. Based on the first input data, the electronic device 204 may be configured to generate a deployment input associated with the set of workload resources. The deployment input is hereinafter referred to as a set of playbooks. In an embodiment, the set of playbooks may correspond to an automation script that may be structured as a Yet Another Markup Language (YAML) file. The set of playbooks may define a sequence of tasks to be executed on one or more target systems (e.g., the computer system 202) associated with the set of workload resources. The set of playbooks may specify the desired state of the computer system 202, including resource provisioning, software installation, configuration management, and orchestration of workflows, enabling repeatable and efficient deployment processes. The electronic device 204 may be further configured to provide the set of playbooks to the computer system 202. Examples of the electronic device 204 may correspond to a computing device such as a personal computer, a workstation, a smartphone, a cellular phone, a mobile phone, and the like.

The electronic device 204 may be further configured to receive second input data from the user 226. The second input data may include parameters or configurations for a virtual deployment instance and may serve as a simulated or isolated representation of an actual deployment. For example, the second input data may include resource allocation (e.g., CPU, memory, storage), specific virtualization technologies (e.g., containerized or hypervisor-based environments), networking configurations, or simulated operational scenarios (e.g., high traffic conditions or failover tests). In an embodiment, the virtual deployment instance may refer to a controlled environment that replicates structure, configuration, and dependencies of a target deployment without utilizing full-scale production resources. The target deployment may be associated with workload resources that may equal to the set of workload resources, less than the set of workload resources, or greater than the set of workload resources. The virtual deployment instance may be used for validation, testing, or staging prior to actual deployment. Based on the second input data, the electronic device 204 may be configured to generate the virtual deployment instance. The electronic device 204 may be further configured to provide the virtual deployment instance to the computer system 202.

The one or more data sources 206 may correspond to an organized collection of a plurality of vulnerabilities associated with the plurality of workload resources. In an embodiment, the plurality of workload resources may include the set of workload resources. Examples of the plurality of vulnerabilities may include common vulnerabilities and exposures (CVEs), misconfigurations, zero-day vulnerabilities, dependency vulnerabilities, and the like. Thus, the one or more data sources 206 may correspond to a centralized storage system where detailed vulnerability information, such as CVE identifiers, severity levels, impacted software versions, and remediation steps, may be stored, managed, and queried.

In an embodiment, the one or more data sources 206 may correspond to public vulnerability repositories or private vulnerability databases. The public vulnerability repositories may include platforms such as the national vulnerability database (NVD), open vulnerability and assessment language (OVAL) repository, common weakness enumeration (CWE) databases, security content automation protocol (SCAP) data sources, and the like. For example, a CVE entry in the NVD database may provide details about a critical vulnerability in a specific container image version. The private vulnerability databases may correspond to organization-specific registries that store proprietary vulnerability assessments or internal security findings. For example, an enterprise may maintain an internal database of vulnerabilities identified through custom scanning tools applied to proprietary container images and may be accessible through authenticated devices. The one or more data sources 206 may enable continuous security analysis and provide the information to mitigate vulnerabilities effectively during deployment and runtime operations.

The server 208 may include suitable logic, circuitry, interfaces, and/or code that may be configured to receive the first input data from the electronic device 204. Upon receiving the first input data, the server 208 may be further configured to store the first input data. The server 208 may be implemented as a cloud server and may execute operations through web applications, cloud applications, HTTP requests, repository operations, file transfer, and the like. Additional example implementations of the server 208 may include, but are not limited to, a database server, a file server, a web server, a media server, an application server, a mainframe server, or a cloud computing server.

In an embodiment of the disclosure, the server 208 may be implemented as a plurality of distributed cloud-based resources by use of several technologies that are well known to those ordinarily skilled in the art. A person with ordinary skill in the art will understand that the scope of the disclosure may not be limited to the implementation of the server 208 and the computer system 202 as two separate entities. In certain embodiments, the functionalities of the server 208 can be incorporated in entirety or at least partially in the computer system 202, without a departure from the scope of the disclosure.

The computer system 202 may include a set of operators 210. The set of operators 210 may include a first operator 210A and a second operator 210B. The first operator 210A and the second operator 210B may include suitable logic, circuitry, interfaces, and/or code that may be configured to perform a set of functions within the computer system 202. The set of functions may include deploying and configuring the set of workload resources, provisioning infrastructure resources, and managing dependencies within the set of workload resources in the computer system 202. Although, it is mentioned that the set of operators 210 may include the first operator 210A and the second operator 210B, in various embodiments, the set of operators 210 may include fewer or additional operators as required by the computer system 202.

In an embodiment, the first operator 210A may be configured to receive a first playbook 212A of the set of playbooks from the electronic device 204. Additionally, the second operator 210B may be configured to receive a second playbook 212B of the set of playbooks from the electronic device 204. For the sake of brevity, it is assumed that the first playbook 212A and the second playbook 212B may differ in scope and purpose. By way of example, and not by limitation, the first playbook 212A may be associated with establishing runtime dependencies among the set of workload resources. Alternatively, the second playbook 212B may be associated with deployment of the set of workload resources.

The first operator 210A may include a first dependency module 212C. The first dependency module 212C may include suitable logic, circuitry, interfaces, and/or code that may be configured to parse the first playbook 212A. In an embodiment, parsing of the first playbook 212A may correspond to an operation to interpret and analyze the first playbook 212A to identify resource definitions associated with the set of workload resources, configuration parameters associated with the set of workload resources, security parameters associated with the set of workload resources, execution directives associated with the set of workload resources, and the like.

In an embodiment, the resource definitions may correspond to formal descriptors that specify characteristics, identity, and intended functions of the set of workload resources. The resource definitions may include resource type, unique identifiers, metadata, and dependency relationships among the set of workload resources. The configuration parameters may correspond to operational setting and options that control deployment and runtime behavior of the set of workload resources. The configuration parameters may include network configurations, resource allocation limits (e.g., CPU and memory), and additional settings to ensure that the set of workload resources functions as per normal operational criteria. The security parameters may correspond to security related settings and attributes that may be associated with the set of workload resources. The security parameters may include encryption configurations, authentication controls, and additional security compliance measures to protect the set of workload resources from unauthorized access or exploitation.

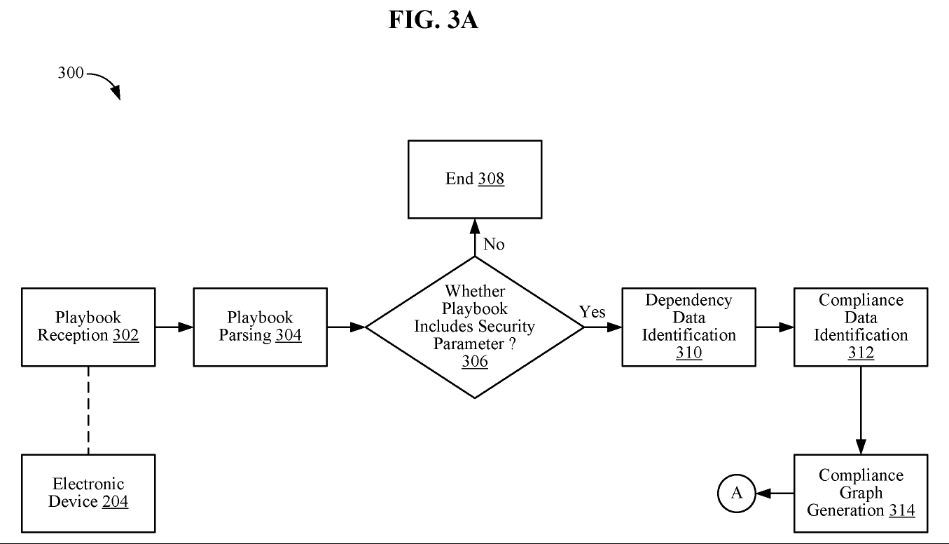

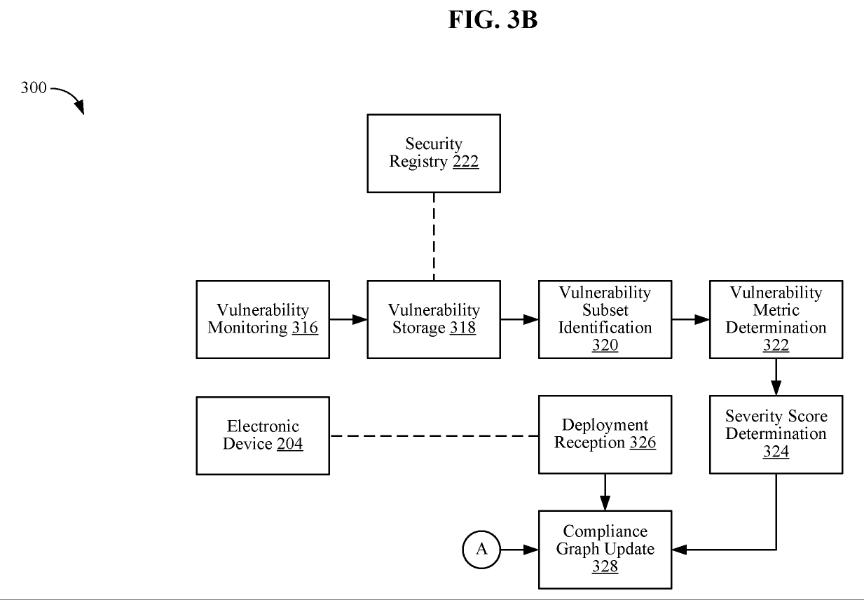

The first dependency module 212C may be further configured to identify a first set of dependencies within the set of workload resources described in the first playbook 212A based on the parsing of the first playbook 212A. Details about the first set of dependencies are provided, for example, in FIG. 3A. Additionally, the first dependency module 212C may be further configured to identify first compliance data associated with the set of workload resources. The first compliance data may include at least one of a first set of cryptographic certificates associated with the set of workload resources or a first set of keys associated with the set of workload resources.

The second operator 210B may include a second dependency module 212D. The second dependency module 212D may include suitable logic, circuitry, interfaces, and/or code that may be configured to parse the second playbook 212B. In an embodiment, the parsing of the second playbook 212B may correspond to an operation to interpret and analyze the second playbook 212B to identify resource definitions associated with the set of workload resources, configuration parameters associated with the set of workload resources, security parameters associated with the set of workload resources, execution directives associated with the set of workload resources, and the like. Based on the parsing of the second playbook 212B, the second dependency module 212D may be further configured to identify a second set of dependencies within the set of workload resources described in the second playbook 212B. Details about the second set of dependencies are provided, for example, in FIG. 3A. Additionally, the second dependency module 212D may be further configured to identify second compliance data associated with the set of workload resources. The second compliance data may include at least one of a second set of cryptographic certificates associated with the set of workload resources or a second set of keys associated with the set of workload resources. The first set of dependencies and the second set of dependencies may be hereinafter collectively referred to as dependency data. Further, the first compliance data and the second compliance data may be hereinafter collectively referred to as compliance data.

The computer system 202 may further include a set of workloads 214. The set of workloads 214 may include a first workload 214A and a second workload 214B. The first workload 214A and the second workload 214B may represent different workloads that may be associated with one or more containerized applications. By way of example, and not by limitation, the set of workloads 214 may correspond to a workflow statefulset, a zen deployment, a message service statefulset, a database initiation job, and the like. Although, it is mentioned that the set of workloads 214 may include the first workload 214A and the second workload 214B, in various embodiments, the set of workloads 214 may include fewer or additional workloads as required by the computer system 202.

The computer system 202 may further include a dependency store 216, a deployment controller 218, a security monitor 220, a security registry 222, and a security handler 224. In an embodiment, the first dependency module 212C may be further configured to store the first set of dependencies and the first compliance data in the dependency store 216. Additionally, the second dependency module 212D may be further configured to store the second set of dependencies and the second compliance data in the dependency store 216. The dependency store 216 may correspond to an organized collection of the dependency data (e.g., the first set of dependencies and the second set of dependencies), and the compliance data (e.g., the first compliance data and the second compliance data).

The deployment controller 218 may include suitable logic, circuitry, interfaces, and/or code that may be configured to retrieve the dependency data from the dependency store 216. The deployment controller 218 may be further configured to retrieve the compliance data associated with the set of workload resources from the dependency store 216. Details about the retrieval of the compliance data are provided, for example, in FIG. 3A. The deployment controller 218 may be further configured to generate a compliance graph associated with the set of workload resources based on dependency data, and the retrieved compliance data associated with the set of workloads 214.

The security monitor 220 may include suitable logic, circuitry, interfaces, and/or code that may be configured to monitor the plurality of vulnerabilities associated with the plurality of workload resources. The security monitor 220 may be further configured to identify a set of vulnerabilities from the monitored plurality of vulnerabilities. The set of vulnerabilities may be associated with the set of workload resources. The security monitor 220 may periodically or continuously query the one or more data sources 206 to identify new, updated, or existing vulnerabilities associated with the plurality of workload resources. The security monitor 220 may be further configured to determine a set of vulnerability metrics associated with the set of vulnerabilities. Details about the determination of the set of vulnerability metrics are provided, for example, in FIG. 3B. The security monitor 220 may be further configured to determine a set of severity scores associated with the set of vulnerability metrics. The set of severity scores may correspond to a numerical representation that may be derived from the set of vulnerability metrics and may be determined using a specific formula that may be defined by a framework (e.g., common vulnerability scoring system). Details about the determination of a set of severity scores are provided, for example, in FIG. 3B. The security monitor 220 may be further configured to provide the set of vulnerabilities, the set of vulnerability metrics, and the set of severity scores to the security registry 222 for storage and subsequent retrieval.

The deployment controller 218 may be further configured to receive the virtual deployment instance from the electronic device 204. Based on the reception of the virtual deployment instance, the deployment controller 218 may be further configured to provide the compliance graph and the virtual deployment instance to the security handler 224 for storage and subsequent retrieval.

The security registry 222 may correspond to an organized collection of vulnerability data and may include the set of vulnerabilities, the set of vulnerability metrics, and the set of severity scores from the security monitor 220. Thus, the security registry 222 may be configured as a compliance registry that archives the vulnerability data for ongoing risk analysis.

The security handler 224 may include suitable logic, circuitry, interfaces, and/or code that may be configured to receive the compliance graph and the virtual deployment instance from the deployment controller 218. Based on the reception of the compliance graph and the virtual deployment instance, the security handler 224 may be further configured to retrieve the set of vulnerability metrics from the security registry 222. Further, the security handler 224 may be configured to update the compliance graph based on the set of vulnerability metrics. The updated compliance graph includes the determined set of severity scores. Details about the updated compliance graph are provided, for example, in FIG. 3B.

In operation, the set of operators 210 may be configured to receive the set of playbooks associated with the set of workload resources from the electronic device 204. The set of operators 210 may be configured to parse the set of playbooks. Based on the parsing of the set of playbooks, the set of operators 210 may be further configured to identify the dependency data associated with the set of workload resources. Additionally, the set of operators 210 may be further configured to identify the compliance data associated with the set of workload resources based on the parsing of the set of playbooks. The set of operators 210 may be further configured to provide the dependency data and the compliance data to the dependency store 216. The deployment controller 218 may be configured to retrieve the dependency data and the compliance data from the dependency store 216. The deployment controller 218 may be further configured to generate the compliance graph associated with the set of workload resources based on the dependency data and the compliance data.

The security monitor 220 may be configured to monitor the plurality of vulnerabilities associated with the plurality of workload resources from the one or more data sources 206. The security monitor 220 may be further configured to identify a set of vulnerabilities from the monitored plurality of vulnerabilities. The security monitor 220 may be further configured to determine the set of vulnerability metrics associated with the set of vulnerabilities. The security monitor 220 may be further configured to determine the set of severity scores associated with the set of vulnerability metrics. The security monitor 220 may be further configured to provide the set of vulnerabilities, the set of vulnerability metrics, and the set of severity scores to the security registry 222.

The deployment controller 218 may be configured to receive the virtual deployment instance associated with the set of workload resources. The deployment controller 218 may be configured to provide the compliance graph and the virtual deployment instance to the security handler 224. The security handler 224 may be further configured to receive the compliance graph and the virtual deployment instance from the deployment controller 218. Based on the reception of the compliance graph and the virtual deployment instance, the security handler 224 may be further configured to retrieve the set of vulnerability metrics from the security registry 222. Further, the security handler 224 may be configured to update the compliance graph based on the set of vulnerability metrics. The updated compliance graph includes the determined set of severity scores.

FIGS. 3A and 3B are diagrams that collectively illustrate exemplary operations for the generation of the compliance graph for the workload resources. FIGS. 3A and 3B are explained in conjunction with elements from FIG. 1, and FIG. 2. With reference to FIGS. 3A and 3B, there is shown a block diagram 300 that illustrates exemplary operations from 302 to 328, as described herein. The exemplary operations illustrated in the block diagram 300 may start at 302 and may be performed by any computing system, apparatus, or device, such as by the computer 102 of FIG. 1 or the computer system 202 of FIG. 2. Although illustrated with discrete blocks, the exemplary operations associated with one or more blocks of the block diagram 300 may be divided into additional blocks, combined into fewer blocks, or eliminated, depending on the particular implementation.

Referring now to FIG. 3A, at 302, a playbook reception operation may be executed. In the playbook reception operation, the set of operators 210 (e.g., the first operator 210A) may be configured to receive the set of playbooks (e.g., the first playbook 212A and the second playbook 212B) from the electronic device 204. The set of playbooks may define a sequence of tasks to be executed on one or more target systems (e.g., the computer system 202). The set of playbooks may specify the desired state of the computer system 202, including resource provisioning, software installation, configuration management, and orchestration of workflows, enabling repeatable and efficient deployment processes.

In an embodiment, the set of playbooks may include resource definitions that describe the plurality of workload resources to be created, configured, or managed within the computer system 202. For example, in the set of playbooks, a host directive may specify a target system (e.g., localhost) to define where tasks should be executed. The set of playbooks may further include task sequences that define ordered or conditional actions to be performed on the plurality of workload resources. Examples of the tasks may include operations such as installing software, applying configuration changes, initiating services, or executing custom scripts.

The set of playbooks may further include dependency declarations that define relationships within the plurality of workload resources or operations. For example, the playbook may use “depends_on” attributes to specify an order in which the plurality of workload resources may be created.

At 304, a playbook parsing operation may be executed. In the playbook parsing operation, the first dependency module 212C may be configured to parse the first playbook 212A. Additionally, the second dependency module 212D may be configured to parse the second playbook 212B. In an embodiment, the playbook parsing operation on the first playbook 212A and the second playbook 212B may correspond to an operation to interpret and analyze the first playbook 212A and the second playbook 212B, respectively to identify security parameters associated with the set of workload resources, resource definitions associated with the set of workload resources, configuration parameters associated with the set of workload resources, execution directives associated with the set of workload resources, and the like.

The first playbook 212A and the second playbook 212B may be represented in a machine-readable format, such as YAML, javascript object notation (JSON), or extensible markup language (XML), and may describe configurations, workflows, dependencies, or tasks associated with the plurality of workload resources.

At 306, it may be determined whether the playbook (e.g., the first playbook 212A and the second playbook 212B) includes security parameter. The first dependency module 212C may be configured to determine whether the first playbook 212A includes a first security parameter based on the parsing of the first playbook 212A. Additionally, the second dependency module 212D may be configured to determine whether the second playbook 212B includes a second security parameter based on the parsing of the second playbook 212B. In case the first playbook 212A and the second playbook 212B may not include the first security parameter and the second security parameter, respectively, the control may pass to end 308. Alternatively, in case the first playbook 212A or the second playbook 212B may include the first security parameter or the second security parameter, respectively, the control may pass to 310.

At 310, a dependency data identification operation may be executed. In the dependency data identification operation, the first dependency module 212C may be configured to identify the first set of dependencies within the workload resources described in the first playbook 212A. The first set of dependencies may be identified based on the determination that the first playbook 212 includes the first security parameter. In an embodiment, the first set of dependencies may include relationships such as resource prerequisites, interconnections, or sequential task execution requirements for deploying and managing the set of workload resources within the computer system 202. For example, the first playbook 212A may define a first deployment where a first pod relies on a configmap for environment variables and a persistent volume for storing data.

The second dependency module 212D may be configured to identify the second set of dependencies within the workload resources described in the second playbook 212B. The second set of dependencies may be identified based on the determination that the second playbook 212B includes the second security parameter. In an embodiment, the second set of dependencies may include relationships such as resource prerequisites, interconnections, or sequential task execution requirements for deploying and managing the set of workload resources within the computer system 202.

At 312, a compliance data identification operation may be executed. In the compliance data identification operation, the first dependency module 212C may be configured to identify the first compliance data associated with the set of workload resources based on the identification of the first set of dependencies. The first compliance data may be identified after the identification of the first set of dependencies. The first compliance data may include at least one of the first set of cryptographic certificates associated with the set of workload resources or the first set of keys associated with the set of workload resources. Additionally, the second dependency module 212D may be further configured to identify the second compliance data associated with the set of workload resources based on the identification of the second set of dependencies. The second compliance data may include at least one of the second set of cryptographic certificates associated with the set of workload resources or the second set of keys associated with the set of workload resources.

The first dependency module 212C may be further configured to store the first set of dependencies and the first compliance data in the dependency store 216. Additionally, the second dependency module 212D may be further configured to store the second set of dependencies and the second compliance data in the dependency store 216. Thus, the dependency store 216 may include the first set of dependencies, the second set of dependencies, and the compliance data (e.g., the first compliance data and the second compliance data).

At 314, a compliance graph generation operation may be executed. In the compliance graph generation operation, the deployment controller 218 may be further configured to retrieve the dependency data stored in the dependency store 216. The deployment controller 218 may be further configured to retrieve the compliance data associated with the set of workload resources stored in the dependency store 216. Further, the deployment controller 218 may be configured to generate the compliance graph associated with the set of workload resources based on the dependency data, and the retrieved compliance data. The compliance graph may represent a compliance status of the set of workload resources and dependencies within the set of workload resources. In an embodiment, the compliance status may correspond to an indicator representing adherence of the set of workload resources and dependencies within the set of workload resources to security and regulatory requirements. By way of example, and not by limitation, the compliance graph may represent whether a database workload resource and an associated web server workload resource, satisfy compliance policies, such as ensuring secure inter-communication. Additionally, the compliance graph may represent whether a microservice workload resource and a caching service workload resource, satisfy access control policies.

Referring now to FIG. 3B, at 316, a vulnerability monitoring operation may be executed. In the vulnerability monitoring operation, the security monitor 220 may be configured to monitor the plurality of vulnerabilities associated with the plurality of workload resources from the one or more data sources 206. The one or more data sources 206 may correspond to public vulnerability repositories (e.g., NVD, OVAL, SCAP, and the like) or private vulnerability databases. In an embodiment, the security monitor 220 may monitor the plurality of vulnerabilities from the one or more data sources 206 in real-time or near real-time.

At 318, a vulnerability storage operation may be executed. In the vulnerability storage operation, the security monitor 220 may be configured to store the set of vulnerabilities in the security registry 222. The security registry 222 may include the set of vulnerabilities in an organized and indexed format for efficient querying and retrieval. In an embodiment, the security registry 222 may associate each vulnerability with specific one of workload resources, workload types, or compliance categories. For example, the security registry 222 may include data indicating that a specific resource (e.g., a database workload resource or a web server workload resource) is affected by a known vulnerability, such as a CVE, and may include details of severity associated with the vulnerability.

In an embodiment, the security registry 222 may be configured to support synchronization of the set of vulnerabilities with external vulnerability databases (e.g., the one or more data sources 206), ensuring that the set of vulnerabilities is updated with the latest information. The security registry 222 may also maintain historical records of vulnerabilities, including detection timestamps, resolution updates, and any associated risk mitigation measures.

At 320, a vulnerability subset identification operation may be executed. In the vulnerability storage operation, the security monitor 220 may be further configured to identify the set of vulnerabilities from the monitored plurality of vulnerabilities. The set of vulnerabilities may be associated with the set of workload resources. The security monitor 220 may periodically or continuously query the one or more data sources 206 to identify new, updated, or existing vulnerabilities associated with the plurality of workload resources.

In an embodiment, if the set of workload resources includes a workload resource that may not be present in the plurality of workload resources, the security monitor 220 may be unable to identify any vulnerabilities associated with the particular workload resource. Thus, vulnerabilities corresponding to the particular workload resource may not be available in the security registry 222.

At 322, a vulnerability metric determination operation may be executed. In the vulnerability metric determination operation, the security monitor 220 may be further configured to determine the set of vulnerability metrics associated with the set of vulnerabilities. In an embodiment, the set of vulnerability metrics may correspond to quantitative measures that may be used to assess the characteristics and potential impact of the set of vulnerabilities within the computer system 202. The set of vulnerability metrics may provide a standardized framework for evaluating various aspects of the set of vulnerabilities, including exploitability, impact on confidentiality, integrity, and availability, as well as the environmental context in which the set of vulnerabilities exists. Examples of the set of vulnerability metrics may include attack vector (method by which an attacker may exploit the vulnerability e.g., local network, adjacent network, and the like), attack complexity (suitable conditions that must exist in order to exploit the vulnerability), privileges (level of privileges an attacker must possess to exploit the vulnerability), scope (the extent to which the exploitation of the set of vulnerabilities may affect the vulnerable component and additional components), and the like.

At 324, a severity score determination operation may be executed. In the severity score determination operation, the security monitor 220 may be configured to process the set of vulnerability metrics. In an embodiment, the security monitor 220 may obtain scoring logic from security framework or databases to ensure consistency in the severity score determination operation. Further, the security monitor 220 may be further configured to determine the set of severity scores associated with the set of vulnerability metrics based on the processing of the set of vulnerability metrics with the scoring logic. The set of severity scores may correspond to a numerical representation that may be derived from the set of vulnerability metrics and may be determined using a specific formula that may be defined by the security framework.

Although it is mentioned that the security monitor 220 may be further configured to determine the set of vulnerability metrics and the set of severity scores, in various embodiments, the security monitor 220 may be further configured to obtain the set of vulnerability metrics and the set of severity scores from third party databases. Thus, by leveraging the third-party databases, the security monitor 220 may access a broader and diverse set of vulnerability metrics, thereby enhancing the overall ability of the computer system 202 to identify vulnerabilities and alert users (e.g., the user 226) about potential vulnerabilities with improved accuracy compared to conventional systems.

In an embodiment, during the severity score determination operation, the security monitor 220 may assess the severity of the set of vulnerabilities based on the set of vulnerability metrics and a standardized framework, such as a common vulnerability scoring system (CVSS). The CVSS may provide a systematic method for rating the set of vulnerabilities. Further, the CVSS may determine the set of severity scores that range from 0 to 10, where scores indicate severity. Each vulnerability of the set of vulnerabilities may be classified into different severity levels based on respective CVSS scores. For example, vulnerabilities with scores ranging from 0.1 to 3.9 may be categorized as “low severity” indicating minimal impact requiring limited attention. Further, vulnerabilities with scores from 4.0 to 6.9 may be classified as “medium severity” indicating a moderate impact warranting timely remediation. Additionally, vulnerabilities with scores between 7.0 and 8.9 may be designated as “high severity” indicating significant risk requiring prompt attention. Finally, vulnerabilities with scores between 9.0 and 10.0 may be categorized as “critical severity” indicating the highest level of severity and requiring immediate action.

By systematically determining both the vulnerability metrics and corresponding severity scores, the security monitor 220 enables efficient prioritization of remediation efforts, ensuring that resources are allocated to address the most critical vulnerabilities in a timely manner. In an embodiment, the security registry 222 may be configured to generate a data structure based on the determination of the set of vulnerability metrics. The data structure may include the set of vulnerabilities, the set of vulnerability metrics, and the set of severity scores. The data structure may correspond to a hierarchical tree, a key-value store, a linked list, and the like. For example, in the relational database, the set of vulnerabilities may be stored as rows, with columns representing the set of vulnerability metrics and the set of severity scores. Alternatively, in the JSON object, the set of vulnerabilities may be represented as objects, and the set of vulnerability metrics and the set of severity scores are stored in key-value pairs. Further, the security monitor 220 may be configured to store the data structure (e.g., the set of vulnerabilities, the set of vulnerability metrics, and the set of severity scores) to the security registry 222.

At 326, a deployment reception operation may be executed. In the deployment reception operation, the deployment controller 218 may be further configured to receive the virtual deployment instance from the electronic device 204. The virtual deployment instance may include configurations and specifications for deploying workload resources in a containerized environment. For example, in the containerized environment, the virtual deployment instance may include a custom resource definition (CRD) that may allow the user 226 to create a custom virtual deployment according to an actual or real deployment in the container-based environment. Based on the reception of the virtual deployment instance, the deployment controller 218 may be further configured to provide the compliance graph and the virtual deployment instance to the security handler 224.

At 328, a compliance graph update operation may be executed. In the compliance graph update operation, the security handler 224 may be further configured to receive the compliance graph and the virtual deployment instance from the deployment controller 218. Based on the reception of the compliance graph and the virtual deployment instance, the security handler 224 may be further configured to retrieve the data structure from the security registry 222. Based on the retrieval of the data structure, the security handler 224 may be further configured to parse the data structure to extract relevant information (e.g., the set of vulnerabilities, the set of vulnerability metrics, and the set of severity scores) associated with the set of workload resources. Further, the security handler 224 may be configured to identify each workload resource of the set of workload resources based on the parsing of the data structure.

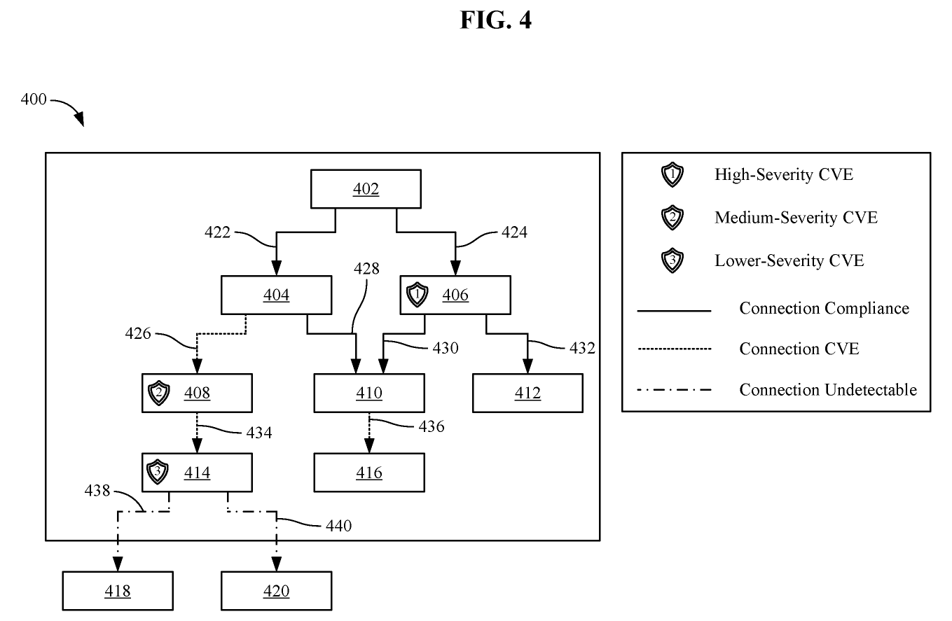

The security handler 224 may be further configured to identify a vulnerability metric from the set of vulnerability metrics for each workload resource of the set of workload resources. The identification of the vulnerability metric from the set of vulnerability metrics is based on the parsing of the data structure. Further, the security handler 224 may be configured to update the compliance graph based on the set of vulnerability metrics. The updated compliance graph includes the determined set of severity scores. Details about the updated compliance graph are provided, for example, in FIG. 4.

The security handler 224 may be further configured to generate an alert based on the updated compliance graph. Further, the security handler 224 may be configured to render the generated alert on a user device (e.g., the electronic device 204). In an embodiment, the security handler 224 may be further configured to render the updated compliance graph on the user device. The operations described in 316 through 328 may be performed continuously such that the compliance graph is dynamic, up-to-date, and includes the vulnerabilities that may affect the set of workload resources.

Although, it is mentioned that the operations described in 316 through 328 may be performed continuously, in various embodiments, the operations may be subject to one or more termination conditions. By way of example, and not by limitation, a first termination condition may correspond to a manual termination initiated by the user 226. Additionally, a second termination condition may correspond to absence of detected vulnerabilities associated with the set of workload resources for a threshold time period (e.g., one year). Upon satisfying the one or more termination conditions, the security monitor may be further configured to suspend or halt the vulnerability monitoring operation.

FIG. 4 is a diagram that illustrates an exemplary compliance graph, in accordance with an embodiment of the disclosure. FIG. 4 is explained in conjunction with elements from FIG. 1, FIG. 2, and FIGS. 3A and 3B. With reference to FIG. 4, there is shown a diagram of an updated compliance graph 400. The updated compliance graph 400 includes a set of nodes and a set of edges. In an embodiment, the set of nodes may correspond to the set of workload resources. The set of nodes may include a first compliance status of the set of workload resources. Further, each edge of the set of edges corresponds to a link or connection between two workload resources of the set of workload resources. The set of edges may include a second compliance status of the link between the two workload resources of the set of workload resources

The set of nodes may include a first workload resource 402, a second workload resource 404, a third workload resource 406, a fourth workload resource 408, a fifth workload resource 410, a sixth workload resource 412, a seventh workload resource 414, and an eighth workload resource 416 that may collectively correspond to the set of workload resources. Additionally, the set of nodes may include a ninth workload resource 418 and a tenth workload resource 420 that may correspond to external workload resources and may represent third-party systems or external services interacting with the set of workload resources. The set of edges may include a first connection 422, a second connection 424, a third connection 426, a fourth connection 428, a fifth connection 430, a sixth connection 432, a seventh connection 434, an eighth connection 436, a ninth connection 438, and a tenth connection 440.

In an embodiment, the compliance graph is generated based on the set of playbooks. Further, the security monitor 220 may monitor the plurality of vulnerabilities associated with the plurality of workload resources from the one or more data sources 206. The security monitor 220 may be further configured to identify the set of vulnerabilities from the monitored plurality of vulnerabilities. The set of vulnerabilities may be associated with the set of workload resources. The security monitor 220 may be further configured to determine the set of vulnerability metrics associated with the set of vulnerabilities. The set of vulnerability metrics may be stored in the security registry 222. Further, based on the virtual deployment instance and the set of vulnerability metrics, the security handler 224 may be configured to update the compliance graph such that the updated compliance graph 400 is generated.

In an embodiment, the set of nodes in the updated compliance graph 400 may include metadata indicating vulnerability status for the set of workload resources. The updated compliance graph 400 as shown in FIG. 4 may include indicators to indicate that the third workload resource 406 is associated with a high severity CVE, the fourth workload resource 408 is associated with a medium severity CVE, and the seventh workload resource 414 is associated with a low severity CVE. Additionally, the updated compliance graph 400 may indicate that the first connection 422, the second connection 424, the fourth connection 428, the fifth connection 430, and the sixth connection 432 are not associated with any CVE and are therefore marked as connection compliance (e.g., the second compliance status) shown by solid lines. Further, the updated compliance graph 400 may indicate that the third connection 426, the seventh connection 434, and the eighth connection 436 are associated with CVE and are therefore marked as connection CVE shown by dotted lines. The updated compliance graph 400 may further indicate that the ninth connection 438 and the tenth connection 440 are unknown or undetectable and are therefore marked as connection undetectable shown by dashed lines.

In an embodiment, the third workload resource 406 may be associated with the high-severity vulnerability affecting the Z shell (zsh) prior to version 5.8.1. The high-severity vulnerability may allow an attacker to execute arbitrary code by manipulating the command output within the shell prompt, specifically through recursive prompt substitution (PROMPT_SUBST) using constructs such as the %F argument. Thus, the third workload resource 406 may include indicators to indicate that the third workload resource 406 is associated with the high severity CVE. Further, the third workload resource 406 may include metadata indicating “High-Severity-CVE: Zsh: CVE-2021-45444.”

In various embodiments, the fourth workload resource 408 may be associated with the medium-severity vulnerability affecting OpenSSH on FreeBSD systems, characterized by a race condition within the SSH daemon (sshd). The medium-severity vulnerability arises when the signal handler, invoked during user authentication timeouts, executes a logging function that is not safe for asynchronous contexts, potentially leading to undefined behavior and allowing unauthenticated remote code execution with root privileges. Thus, the fourth workload resource 408 may include indicators to indicate that the fourth workload resource 408 is associated with the medium severity CVE. Further, the fourth workload resource 408 may include metadata indicating “Medium-Severity-CVE: OpenSSH: CVE-2024-7589.” Additionally, the remaining workload resources (the first workload resource 402, the second workload resource 404, the fifth workload resource 410, the sixth workload resource 412, and the eighth workload resource 416) may not be associated with any CVE and thus may not have any indicators or metadata thereby indicating workload resource compliance (e.g., the first compliance status).

The security handler 224 may be further configured to generate the alert based on the updated compliance graph 400. Further, the security handler 224 may be configured to render the generated alert on the user device (e.g., the electronic device 204, a mobile device, a smart wearable device, and the like). In an embodiment, the security handler 224 may be further configured to render the updated compliance graph 400 on the user device to inform the user 226 about the CVEs. Thus, based on the updated compliance graph 400, the computer system 202 may provide prompt status updates upon detecting new security vulnerabilities.

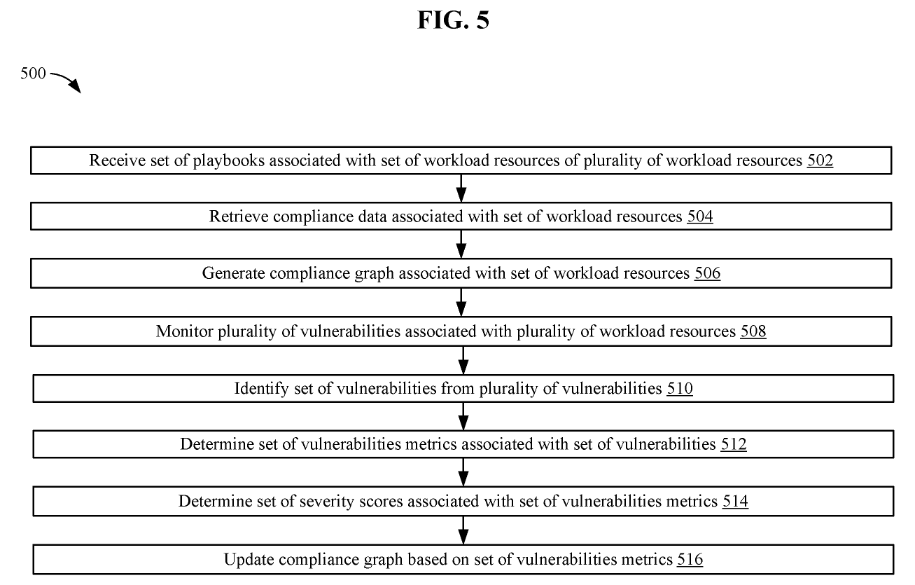

FIG. 5 is a diagram that illustrates a flowchart of an exemplary method for the generation of the compliance graph for the workload resources. FIG. 5 explained in conjunction with elements from FIG. 1, FIG. 2, FIGS. 3A and 3B, and FIG. 4. With reference to FIG. 5, there is shown a flowchart 500. The operations of the exemplary method may be executed by any computing system, for example, by the computer 102 of FIG. 1 or the computer system 202 of FIG. 2. The operations of the flowchart 500 may start at 502.

At 502, the set of playbooks associated with the set of workload resources is received. In an embodiment of the disclosure, the set of operators 210 may be configured to receive the set of playbooks. The set of operators 210 may be configured to parse the set of playbooks. Based on the parsing of the set of playbooks, the set of operators 210 may be further configured to identify the dependency data associated with the set of workload resources. Additionally, the set of operators 210 may be further configured to identify the compliance data associated with the set of workload resources based on the parsing of the set of playbooks. The set of operators 210 may be further configured to provide the dependency data and the compliance data to the dependency store 216. Details about the parsing of the set of playbooks are provided, for example, in FIG. 2 and FIG. 3A.

At 504, the compliance data associated with the set of workload resources is retrieved. In an embodiment of the disclosure, the deployment controller 218 may be configured to retrieve the dependency data and the compliance data. The dependency data and the compliance data may be retrieved from the dependency store 216. The compliance data may include cryptographic certificates associated with the set of workload resources or the first set of keys associated with the set of workload resources. Details about the retrieval of the compliance data are provided, for example, in FIG. 2 and FIG. 3A.

At 506, the compliance graph associated with the set of workload resources is generated. In an embodiment of the disclosure, the deployment controller 218 may be configured to generate the compliance graph associated with the set of workload resources based on the dependency data and the compliance data. Details about the generation of the compliance graph are provided, for example, in FIG. 2 and FIG. 3A.

At 508, the plurality of vulnerabilities associated with the plurality of workload resources is monitored. In an embodiment of the disclosure, the security monitor 220 may be configured to monitor the plurality of vulnerabilities associated with the plurality of workload resources. The plurality of vulnerabilities may be monitored from the one or more data sources 206. Details about the monitoring of the plurality of vulnerabilities are provided, for example, in FIG. 2 and FIG. 3B.

At 510, the set of vulnerabilities from the plurality of vulnerabilities are identified. In an embodiment of the disclosure, the security monitor 220 may be further configured to identify the set of vulnerabilities from the monitored plurality of vulnerabilities. Details about the identification of the set of vulnerabilities are provided, for example, in FIG. 2 and FIG. 3B.

At 512, the set of vulnerability metrics associated with the set of vulnerabilities is determined. In an embodiment of the disclosure, the security monitor 220 may be configured to determine the set of vulnerability metrics associated with the set of vulnerabilities. Details about the determination of the set of vulnerability metrics are provided, for example, in FIG. 2 and FIG. 3B.

At 514, the set of severity scores associated with the set of vulnerability metrics is determined. In an embodiment of the disclosure, the security monitor 220 may be configured to determine the set of severity scores associated with the set of vulnerability metrics. The security monitor 220 may be further configured to provide the set of vulnerabilities, the set of vulnerability metrics, and the set of severity scores to the security registry 222. Details about the determination of the set of severity scores are provided, for example, in FIG. 2, FIG. 3B, and FIG. 4.

At 516, the compliance graph is updated based on the set of vulnerability metrics. In an embodiment of the disclosure, the security handler 224 may be configured to update the compliance graph based on the set of vulnerability metrics. The updated compliance graph includes the determined set of severity scores. Further, the security handler 224 may be configured to render the generated alert on a user device (e.g., the electronic device 204, a mobile device, a smart wearable device, and the like). In an embodiment, the security handler 224 may be further configured to render the updated compliance graph on the user device. Details about the updating of the compliance graph are provided, for example, in FIG. 2, FIG. 3B, and FIG. 4.

The descriptions of the various embodiments of the disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable a reader of ordinary skill in the art to understand the embodiments disclosed herein.

What is claimed is:

1. A computer-implemented method, comprising:
receiving, by a computer, a deployment input associated with a set of workload resources;
retrieving, by the computer, compliance data based on the received deployment input, wherein the retrieved compliance data is associated with the set of workload resources, and wherein the retrieved compliance data comprises at least one of a set of cryptographic certificates associated with the set of workload resources or a set of keys associated with the set of workload resources;
generating, by the computer, a compliance graph associated with the set of workload resources based on the retrieved compliance data;
monitoring, by the computer, a plurality of vulnerabilities associated with a plurality of workload resources based on the generated compliance graph, wherein the plurality of workload resources comprises the set of workload resources, and wherein the plurality of vulnerabilities comprises a set of common vulnerability exposures;
identifying, by the computer, a set of vulnerabilities from the monitored plurality of vulnerabilities, wherein the identified set of vulnerabilities impacts at least one application installed on the set of workload resources;
determining, by the computer, a set of vulnerability metrics associated with the identified set of vulnerabilities;
determining, by the computer, a set of severity scores associated with the set of vulnerability metrics; and
updating, by the computer, the compliance graph based on the determined set of vulnerability metrics, wherein the updated compliance graph comprises the determined set of severity scores.

2. The computer-implemented method of claim 1, further comprising:
generating, by the computer, a data structure based on the determination of the set of vulnerability metrics, wherein the data structure comprises the identified set of vulnerabilities and the determined set of vulnerability metrics;
parsing, by the computer, the data structure;
identifying, by the computer, a workload resource from the set of workload resources based on the parsing of the data structure;
identifying, by the computer, a vulnerability metric from the determined set of vulnerability metrics based on the parsing of the data structure, wherein the identified vulnerability metric is associated with the identified workload resource; and
updating, by the computer, the compliance graph based on the identified workload resource and the identified vulnerability metric.

3. The computer-implemented method of claim 1, wherein the compliance graph comprises a set of nodes and a set of edges, and wherein
the set of nodes corresponds to the set of workload resources, and
each edge of the set of edges corresponds to a link between two workload resources of the set of workload resources.

4. The computer-implemented method of claim 3, wherein the set of nodes comprises a first compliance status of the set of workload resources, and wherein the set of edges comprise a second compliance status of the link between the two workload resources of the set of workload resources.

5. The computer-implemented method of claim 1, wherein the deployment input corresponds to at least one of a set of instructions associated with deployment of the set of workload resources or configuration data associated with the deployment of the set of workload resources.

6. The computer-implemented method of claim 1, further comprising:
generating, by the computer, an alert based on the updated compliance graph; and
rendering, by the computer, the generated alert on a user device.

7. The computer-implemented method of claim 1, further comprising determining, by the computer, the set of severity scores based on the set of vulnerability metrics and a common vulnerability scoring system.

8. The computer-implemented method of claim 1, wherein the set of workload resources comprises at least one of a set of pods or a set of containers.

9. A computer system, comprising:
a processor set;
one or more computer-readable storage media; and
program instructions stored on the one or more computer-readable storage media, the program instructions executable by the processor set to cause the processor set to:
receive a deployment input associated with a set of workload resources;
retrieve compliance data based on the received deployment input, wherein the retrieved compliance data is associated with the set of workload resources, and wherein the retrieved compliance data comprises at least one of a set of cryptographic certificates associated with the set of workload resources or a set of keys associated with the set of workload resources;
generate a compliance graph associated with the set of workload resources based on the retrieved compliance data;
monitor a plurality of vulnerabilities associated with a plurality of workload resources based on the generated compliance graph, wherein the plurality of workload resources comprises the set of workload resources, and wherein the plurality of vulnerabilities comprises a set of common vulnerability exposures;
identify a set of vulnerabilities from the monitored plurality of vulnerabilities, wherein the identified set of vulnerabilities impacts at least one application installed on the set of workload resources;
obtain a set of vulnerability metrics associated with the identified set of vulnerabilities;
obtain a set of severity scores associated with the set of vulnerability metrics;
update the compliance graph based on the obtained set of vulnerability metrics, wherein the updated compliance graph comprises the obtained set of severity scores; and
render the updated compliance graph on a user device.

10. The computer system of claim 9, wherein the program instructions further cause the processor set to:
generate a data structure based on the obtained set of vulnerability metrics, wherein the data structure comprises the identified set of vulnerabilities and the obtained set of vulnerability metrics;
parse the data structure;
identify a workload resource from the set of workload resources based on the parsed data structure;
identify a vulnerability metric from the obtained set of vulnerability metrics based on the parsed data structure, wherein the identified vulnerability metric is associated with the identified workload resource; and
update the compliance graph based on the identified workload resource and the identified vulnerability metric.

11. The computer system of claim 9, wherein the compliance graph comprises a set of nodes and a set of edges, and wherein
the set of nodes corresponds to the set of workload resources, and
each edge of the set of edges corresponds to a link between two workload resources of the set of workload resources.

12. The computer system of claim 11, wherein the set of nodes comprises a first compliance status of the set of workload resources, and wherein the set of edges comprise a second compliance status of the link between the two workload resources of the set of workload resources.

13. The computer system of claim 9, wherein the deployment input corresponds to at least one of a set of instructions associated with deployment of the set of workload resources or configuration data associated with the deployment of the set of workload resources.

14. The computer system of claim 9, wherein the program instructions further cause the processor set to:
generate an alert based on the updated compliance graph; and
render the generated alert on the user device.

15. The computer system of claim 9, the program instructions further cause the processor set to obtain the set of severity scores based on the set of vulnerability metrics and a common vulnerability scoring system.

16. The computer system of claim 9, wherein the set of workload resources comprises at least one of a set of pods or a set of containers.

17. A computer-program product for generation of a compliance graph associated with a set of workload resources, the computer-program product comprising:
one or more computer-readable storage media; and
program instructions stored on the one or more computer-readable storage media to perform operations comprising:
receiving a deployment input associated with the set of workload resources;
retrieving compliance data based on the received deployment input, wherein the retrieved compliance data is associated with the set of workload resources, and wherein the retrieved compliance data comprises at least one of a set of cryptographic certificates associated with the set of workload resources or a set of keys associated with the set of workload resources;
generating the compliance graph associated with the set of workload resources based on the retrieved compliance data;
monitoring a plurality of vulnerabilities associated with a plurality of workload resources based on the generated compliance graph, wherein the plurality of workload resources comprises the set of workload resources, and wherein the plurality of vulnerabilities comprises a set of common vulnerability exposures;
identifying a set of vulnerabilities from the monitored plurality of vulnerabilities, wherein the identified set of vulnerabilities impacts at least one application installed on the set of workload resources;
determining a set of vulnerability metrics associated with the identified set of vulnerabilities;
determining a set of severity scores associated with the set of vulnerability metrics; and
updating the compliance graph based on the determined set of vulnerability metrics, wherein the updated compliance graph comprises the determined set of severity scores.

18. The computer-program product of claim 17, wherein the program instructions stored on the one or more computer-readable storage media perform the operations further comprising:
generating a data structure based on the determination of the set of vulnerability metrics, wherein the data structure comprises the identified set of vulnerabilities and the determined set of vulnerability metrics;
parsing the data structure;
identifying a workload resource from the set of workload resources based on the parsing of the data structure;
identifying a vulnerability metric from the determined set of vulnerability metrics based on the parsing of the data structure, wherein the identified vulnerability metric is associated with the identified workload resource; and
updating the compliance graph based on the identified workload resource and the identified vulnerability metric.

19. The computer-program product of claim 17, wherein the compliance graph comprises a set of nodes and a set of edges, and wherein
the set of nodes corresponds to the set of workload resources, and
each edge of the set of edges corresponds to a link between two workload resources of the set of workload resources.

20. The computer-program product of claim 19, wherein the set of nodes comprises a first compliance status of the set of workload resources, and wherein the set of edges comprise a second compliance status of the link between the two workload resources of the set of workload resources.
